(19) United States
(12) Patent Application Publication
(10) Pub. No.: US 2002/0066884 A1
(43) Pub. Date: Jun. 6, 2002

(54) ETCHING GAS FOR SILICON ETCH BACK

(76) Inventors: NIEN-YU TSAI, TAIPEI (TW); TE-HSUN PANG, CHU-CHI HSIANG (TW); RAY LEE, TAIPEI (TW); MU-TSUN TING, TAI-HSI HSIANG (TW)

Correspondence Address: J C PATENTS INC, 4 Venture, Suite 250, IRVINE, CA, 92618, US

(21) Appl. No.: 09/396,500

(22) Filed: Sep. 10, 1999

(51) Int. Cl. C09K 13/00

(52) U.S. Cl. 252/79.1

(57) ABSTRACT

An etching gas having a good chemical property for silicon etch back is made by mixing a SF₆ gas with a Cl₂ gas. With addition of an inert gas, good chamber conditions are maintained during silicon etch back, and the etching selectivity for silicon to an etching stop layer is improved.

### BACKGROUND OF THE INVENTION

1. Field of Invention

The present invention relates to an etching gas for an etching process. More particularly, the present invention relates to an etching gas having a good chemical property for silicon etch back.

2. Description of Related Art

Silicon etch back is a common step in the semiconductor process. Silicon etch back is performed in various situations such as after a deep trench is filled with silicon to form a capacitor and after a contact window is filled with silicon to form a plug.

FIG. 1A and FIG. 1B are schematic, cross-sectional diagrams illustrating a capacitor structure during silicon filling and etch back.

Referring to both FIG. 1A and FIG. 1B, a deep trench 106 is formed by performing photolithography and etching in a substrate 100, with a silicon nitride pad layer 104 and a silicon oxide pad layer 102 serving as a hard mask. Since the deep trench 106 serves as a capacitor for dynamic random access memory (DRAM), an electrode and a dielectric layer are formed within this deep trench 106, wherein the electrode is usually made of silicon.

In order to fill the deep trench 106 with silicon, a silicon layer 108 is commonly formed to cover the silicon nitride pad layer 104, and also fill the deep trench 106. An etch back process is then performed to remove a part of the silicon layer 108 that covers the silicon nitride pad layer so as to form a silicon plug 110. Subsequent processes are performed to complete the manufacture of the deep trench capacitor.

Reference is made to FIG. 2A and FIG. 2B, which are schematic, cross-sectional diagrams illustrating a contact window structure in which a silicon plug is formed by filling the contact window with silicon and followed by performing silicon etch back.

In order to fill a contact window 204, which is located in an oxide layer 202 above a substrate 200, with silicon, a silicon layer 206 is commonly formed to cover the oxide layer 202, and also fill the contact window 204. An etch back process is then performed to remove a part of the silicon layer 206 that covers the oxide layer 202 so as to form a silicon plug 208.

Conventionally, a sulfur hexafluoride (SF₆) gas and a carbon tetrafluoride (CF₄) gas are mixed to produce an etching gas for the etch back process mentioned above. Generally, the CF₄ gas is advantageous for improving the uniformity during silicon etch back.

However, during the silicon etch back, the CF₄ gas may attack some chamber parts, especially those made of quartz or ceramic, so as to cause contamination in the chamber and erosion to the chamber parts. This further causes a reliability problem and necessitates the frequent replacement of the chamber parts due to their short lifetime during device manufacture.

Furthermore, a huge amount of polymers is produced from the CF₄ gas during silicon etch back and accumulates on the inner surfaces of the chamber. As a result, frequent preventive maintenance is required; thus, the product throughput is reduced.

In addition, the CF₄ gas does not have a high etching selectivity for silicon to the etching stop layer such as a silicon nitride layer or a silicon oxide layer during silicon etch back. As a result, it may easily cause a loss of the etching stop layer and other difficulties in the subsequent process.

### SUMMARY OF THE INVENTION

The invention provides an etching gas having a good chemical property for silicon etch back to yield better chamber conditions and higher etching selectivity for silicon to the etching stop layer. This solves problems such as chamber part damage, contamination in the chamber, and low etching selectivity for silicon to the etching stop layer that manifest when the conventional etching gas was used.

As embodied and broadly described herein, the invention provides an etching gas having a good chemical property for silicon etch back and is applicable to semiconductor processes such as formation of a silicon plug, formation of a deep trench capacitor, and formation of a silicon spacer. The etching gas mainly comprises a SF₆ gas and a Cl₂ gas, wherein the SF₆ gas and the Cl₂ gas are mixed in a ratio of about 1:2. The SF₆ gas has a flow rate of about 10-50 sccm and preferably has a flow rate of about 30 sccm, whereas the Cl₂ gas has a flow rate of about 20-100 sccm and preferably has a flow rate of about 60 sccm.

It is noted that the etching gas may further include an inert gas.

The etching gas having a good chemical property for silicon etch back is provided by mixing a SF₆ gas with a Cl₂ gas. However, with addition of the inert gas, better chamber conditions are obtained during silicon etch back, and the etching selectivity for silicon to the etching stop layer is enhanced, as well.

The etching gas provided by the invention can reduce the damage done to the chamber parts in the chamber so as to increase the lifetime of the chamber parts. Furthermore, the etching chamber is not readily contaminated when the etching gas provided by the invention is used. Thus, device reliability is improved. Since the etching gas disclosed in the invention reduces the rate for polymer deposition on the inner surface of the chamber, the frequency of preventive maintenance for the reactive chamber is reduced. In addition, the etching gas disclosed in the invention improves the etching selectivity for silicon to the etching stop layer.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B are schematic, cross-sectional diagrams illustrating a capacitor structure during the filling with silicon process and etch back; and

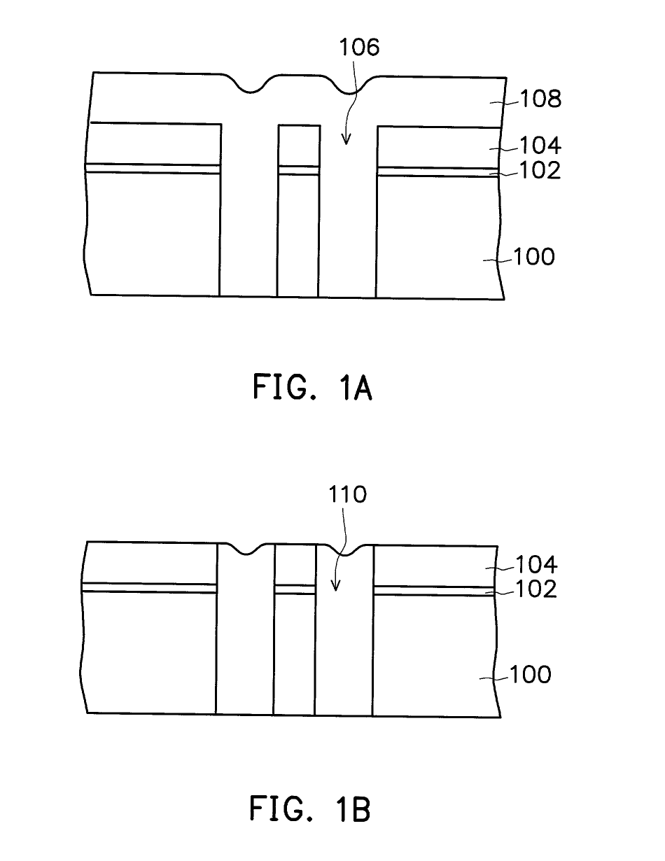

FIG. 2A and FIG. 2B are schematic, cross-sectional diagrams illustrating a contact window for forming a silicon plug during the filling with silicon process and etch back.

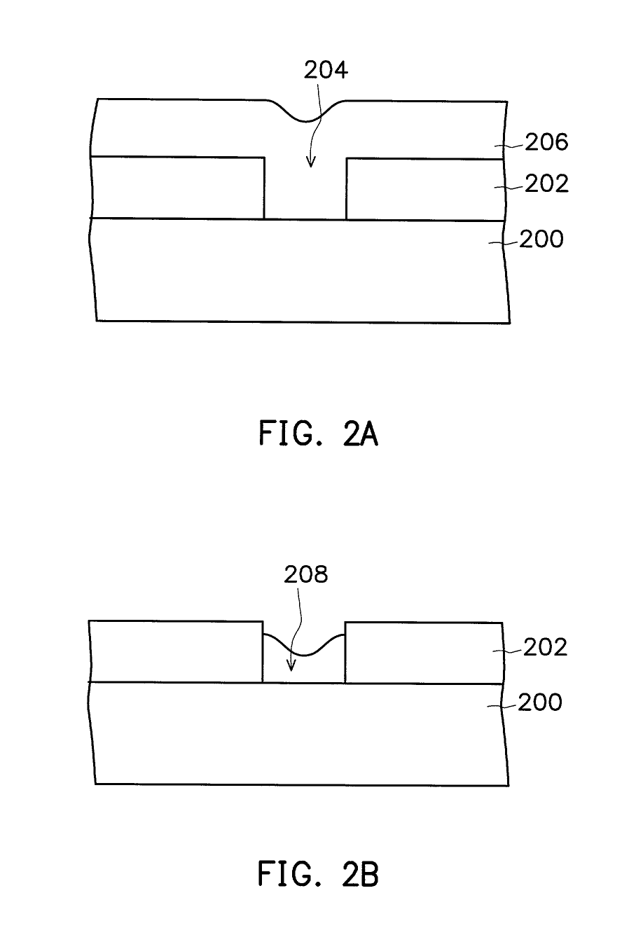

### DESCRIPTION OF THE PREFERRED EMBODIMENTS

The invention provides an etching gas having a good chemical property for silicon etch back and is applicable to steps in the semiconductor process such as formation of a silicon plug, formation of a deep trench capacitor, and formation of a silicon spacer.

The invention involves mixing a sulfur hexafluoride (SF₆) gas and a chlorine (Cl₂) gas, wherein the gas mixture serve as an etching gas used during silicon etch back. The silicon material in this case may include doped or undoped polysilicon and amorphous silicon.

When silicon etch back is performed in a reactive chamber, the above problem caused by use of the conventional etching gas is solved if the SF₆ gas and the Cl₂ gas are mixed with a specific ratio. The preferred ratio for mixing the SF₆ gas and the Cl₂ gas is about 1:2.

The SF₆ gas in this case has a flow rate of about 10-50 standard cubic centimeters per minute (sccm), whereas the Cl₂ gas has a flow rate of about 20-100 sccm. Preferably, the SF₆ gas has a flow rate of about 30 sccm, whereas the SF₆ gas has a flow rate of about 60 sccm.

The etching chamber in this case may include a decoupled plasma source (DPS) chamber, a reactive ion etching (RIE) chamber, a magnetically enhanced reactive ion etching (MERIE) chamber, or a down stream etching (DSE) chamber.

If the SF₆ gas and the Cl₂ gas are mixed to form the etching gas for silicon etch back, the plasma formed as such results in a lower sputter rate for chamber parts in the chamber than that resulting from plasma formed by the conventional etching gas. Some components in the chamber parts, such as the sputtered aluminum (Al), are thus reduced so as to lessen the contamination in the chamber.

When the SF₆ gas and the Cl₂ gas are mixed as described during silicon etch back, the chamber parts in the chamber are not damaged and the etching chamber is not contaminated. Hence, it is not necessary to replace the chamber parts frequently because they have a longer lifetime, while the reliability of the device is also improved during device manufacture.

It is understood from the experimental data that the rate of polymer deposition on the inner surfaces of the chamber is about 1300 angstroms per hour when performing using the conventional etching gas. However, if silicon etch back is performed using the etching gas disclosed in the invention, the rate of polymer deposition on the inner surfaces of the chamber is reduced to about 120 angstroms per hour. So, when the SF₆ gas and the Cl₂ gas are mixed to form the etching gas for silicon etch back, fewer polymers are produced as a result of silicon etch back and accumulate on the inner surfaces of the chamber. Therefore, it is not necessary to perform preventive maintenance with high frequency, so the throughput of the product is reduced.

Generally, when silicon etch back is performed using the conventional etching gas, the mean time between wet cleanings for the etching chamber is about 35 hours. In contrast, if silicon etch back is performed using the etching gas disclosed in the invention, the mean time between wet cleanings for the etching chamber is about 100 hours. This indicates that the invention effectively reduces the frequency for cleaning the etching chamber.

Furthermore, since the SF₆ gas and the Cl₂ gas are mixed to form the etching gas for silicon etch back, problems such as low etching selectivity for silicon to the etching stop layer and the loss of the etching stop layer during etch back are solved.

When silicon etch back is performed using the conventional etching gas, the etching selectivity for silicon to silicon nitride is about 1.2, while the etching selectivity for polysilicon to silicon oxide is about 1.4. However, if silicon etch back is performed using the etching gas disclosed in the invention, the etching selectivity for silicon to silicon nitride increases to approximately 3, while the etching selectivity for polysilicon to silicon oxide increases to approximately 6. This indicates that the invention increases the etching selectivity for silicon to the etching stop layer.

In addition to the etching gases having good chemical property for etching back silicon as described above, some inert gases, such as helium (He), argon (Ar), xenon (Xe), and krypton (Kr) disclosed in the invention are usually added to enhance the uniformity of the chip during etching. Such addition also reduces a microloading effect.

The etching gas having a good chemical property for silicon etch back is provided by mixing a SF₆ gas with a Cl₂ gas. However, with addition of the inert gas, better chamber conditions are obtained during silicon etch back, and the etching selectivity for silicon to the etching stop layer is enhanced.

The etching gas provided by the invention can reduce the damage done to the chamber parts in the chamber, so the lifetime of the chamber parts increases. Also, the etching chamber is not readily contaminated when the etching gas provided by the invention is used. Thus, the device reliability is improved during manufacture. Since the etching gas disclosed in the invention reduces the rate for depositing polymer around the inner surface of the chamber, the frequency of preventive maintenance for the reactive chamber is reduced. In addition, the etching gas disclosed in the invention improves the etching selectivity for silicon to the etching stop layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An etching gas having a good chemical property for silicon etch back, comprising of:
a sulfur hexafluoride (SF₆) gas; and
a chlorine (Cl₂) gas.

2. The etching gas of claim 1, wherein the SF₆ gas and the Cl₂ gas are mixed in a ratio of about 1:2.

3. The etching gas of claim 1, wherein the SF₆ gas has a flow rate of about 10-50 standard cubic centimeters per minute (SCCM).

4. The etching gas of claim 3, wherein the Cl₂ gas has a flow rate of about 20-100 SCCM.

5. The etching gas of claim 1, wherein the Cl₂ gas has a flow rate of about 20-100 SCCM.

6. The etching gas of claim 1, wherein the SF₆ gas has a flow rate of about 30 SCCM.

7. The etching gas of claim 6, wherein the Cl₂ gas has a flow rate of about 60 SCCM.

8. The etching gas of claim 1, wherein the Cl₂ gas has a flow rate of about 60 SCCM.

9. The etching gas of claim 1, further comprising an inert gas.

10. An etching gas applicable to silicon etch back, the etching gas comprising:
a SF₆ gas; and
a Cl₂ gas, wherein the SF₆ gas and the Cl₂ gas are mixed in a ratio of about 1:2.

11. The etching gas of claim 10, wherein the SF₆ gas has a flow rate of about 10-50 SCCM.

12. The etching gas of claim 10, wherein the Cl₂ gas has a flow rate of about 20-100 SCCM.

13. The etching gas of claim 10, wherein the SF₆ gas has a flow rate of about 30 SCCM.

14. The etching gas of claim 10, wherein the Cl₂ gas has a flow rate of about 60 SCCM.

15. The etching gas of claim 10, further comprising an inert gas.

16. The etching gas of claim 10, wherein the silicon etch back is a process applicable to formation of a silicon plug, formation of a deep trench capacitor, or formation of a silicon spacer.
